(19) United States
(12) Patent Application Publication
(10) Pub. No.: US 2014/0354577 A1
(43) Pub. Date: Dec. 4, 2014

(54) Multi-State Capacitive Button

(71) Applicants: Ingar Hanssen, Trondheim (NO); Arild Rødland, Trondheim (NO); Rian Whelan, Drogheda (IE)

(72) Inventors: Ingar Hanssen, Trondheim (NO); Arild Rødland, Trondheim (NO); Rian Whelan, Drogheda (IE)

(21) Appl. No.: 13/903,599

(22) Filed: May 28, 2013

(51) Int. Cl. G06F 3/044

(52) U.S. Cl. CPC G06F 3/044
USPC 345/174

(57) ABSTRACT

In one embodiment, an apparatus includes a capacitive sensor, a button, a support, and a controller. The button includes a first material having a distal coupling portion and a proximal coupling portion. The distal coupling portion is distal from the capacitive sensor and configured to capacitively couple with an object. The proximal coupling portion is proximal to the capacitive sensor and configured to capacitively couple with the capacitive sensor. The support is connected to the button and configured to deflect when the button is pressed. The controller is connected to the capacitive sensor and configured to measure a value associated with an amount of capacitive coupling between the button and the capacitive sensor, which is based on an amount of capacitive coupling between the distal coupling portion and the object and a distance between the proximal coupling portion and the capacitive sensor.

### TECHNICAL FIELD

This disclosure relates generally to touch sensor technology, and more particularly to a multi-state capacitive button.

### BACKGROUND

A touch sensor may detect the presence and location of a touch or the proximity of an object (such as a user's finger or a stylus) within a touch-sensitive area of the touch sensor. A touch sensor may be attached to or provided as part of a desktop computer, laptop computer, tablet computer, personal digital assistant (PDA), Smartphone, satellite navigation device, portable media player, portable game console, kiosk computer, point-of-sale device, or other suitable device. A control panel on a household or other appliance may include a touch sensor.

There are a number of different types of touch sensors, such as (for example) resistive touch screens, surface acoustic wave touch screens, and capacitive touch screens. When an object touches or comes within proximity of the surface of the capacitive touch sensor, a change in capacitance may occur within the touch sensor at the location of the touch or proximity. A touch-sensor controller may process the change in capacitance to determine the object's position relative to the touch sensor.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an example device that may utilize multi-state capacitive buttons;

FIG. 2 illustrates a portion of an example keyboard, touch sensor, and touch-sensor controller that may be used in the device of FIG. 1;

FIG. 3 illustrates an example touch sensor and touch-sensor controller that may be used in certain embodiments of FIG. 2;

FIG. 4 illustrates example components that may be used in the keyboard of FIG. 2;

FIG. 5A illustrates an example state of the button of FIG. 4;

FIG. 5B illustrates an example state of the button of FIG. 4;

FIG. 5C illustrates an example state of the button of FIG. 4;

FIG. 5D illustrates an example state of the button of FIG. 4;

FIG. 6 illustrates a graph of example measurements that may be made by one or more components of FIG. 2;

FIG. 7A illustrates an example configuration of the touch sensor of FIG. 2;

FIG. 7B illustrates an example configuration of the touch sensor of FIG. 2;

FIG. 7C illustrates an example configuration of the touch sensor of FIG. 2;

FIG. 7D illustrates an example configuration of the touch sensor of FIG. 2; and

FIG. 8 illustrates an example keyboard sensing sequence that may be performed with a multi-state capacitive button.

### DESCRIPTION OF EXAMPLE EMBODIMENTS

In particular embodiments of a multi-state capacitive button, a capacitive sensor underlying a button may be configured to identify multiple states associated with the button. For example, the capacitive keyboard may detect whether a button is depressed, whether an object is in contact with the button, the position of an object relative to the button, or any combination thereof. A portion of the button proximate to the underlying capacitive sensor may capacitively couple with the underlying capacitive sensor such that the electrical field generated by the capacitive sensor is conveyed to a distal portion of the button. Capacitive coupling between the object and the distal portion of the button may affect the capacitive coupling between the proximate portion of the button and the underlying capacitive sensor, thereby changing a capacitive measurement by the sensor. Since this capacitive effect may vary depending on the proximity of the object to the button and the proximity of the button to the underlying capacitive sensor, such embodiments may enable the determination of the object's position relative to the button and the extent to which the button is depressed.

A multi-state capacitive button may provide various technical advantages. One technical advantage may be the ability to measure button presses using capacitive measurements. A multi-state capacitive button may also enable mechanical and/or tactile feedback by providing touch-sensitive regions associated with movable buttons. As another example of a technical advantage, certain embodiments may improve the ability to perform proximity sensing in keyboards utilizing a housing of grounded metal surrounding the buttons. Furthermore, certain embodiments may allow multiple simultaneous key presses to be detected without requiring the use of diodes in certain capacitive keyboards. Removing the need for certain hardware components may also provide cost savings and simplify production. As another example, the capacitive functionality of a multi-state capacitive button may enable the detection of various states of button depression and object proximity. Detection of these states may enable the triggering of various beneficial keyboard functions. For example, user proximity-detection may allow an associated device to “wake up” from a hibernating state, allowing devices to save power and other resources when the user is away and allowing for quicker reactivation when the user returns. Such proximity-detection may also enable the triggering of various other functions, such as turning on a keyboard light, triggering various device features, or activating additional components. Certain embodiments of a multi-state capacitive button may also allow devices to distinguish between buttons pressed by a finger and buttons pressed by other objects, which may improve the ability of devices to distinguish between purposeful and accidental touches. Certain embodiments of a multi-state capacitive button may also provide capacitive keyboard functionality that does not require creating galvanic connections to detect key presses, which may reduce mechanical wear on certain components and reduce the frequency and/or cost of repairs. Furthermore, certain embodiments may provide improved electrical isolation, which may provide improved safety and/or improve water resistance. Various embodiments of the present disclosure may include all, some, or none of the above benefits.

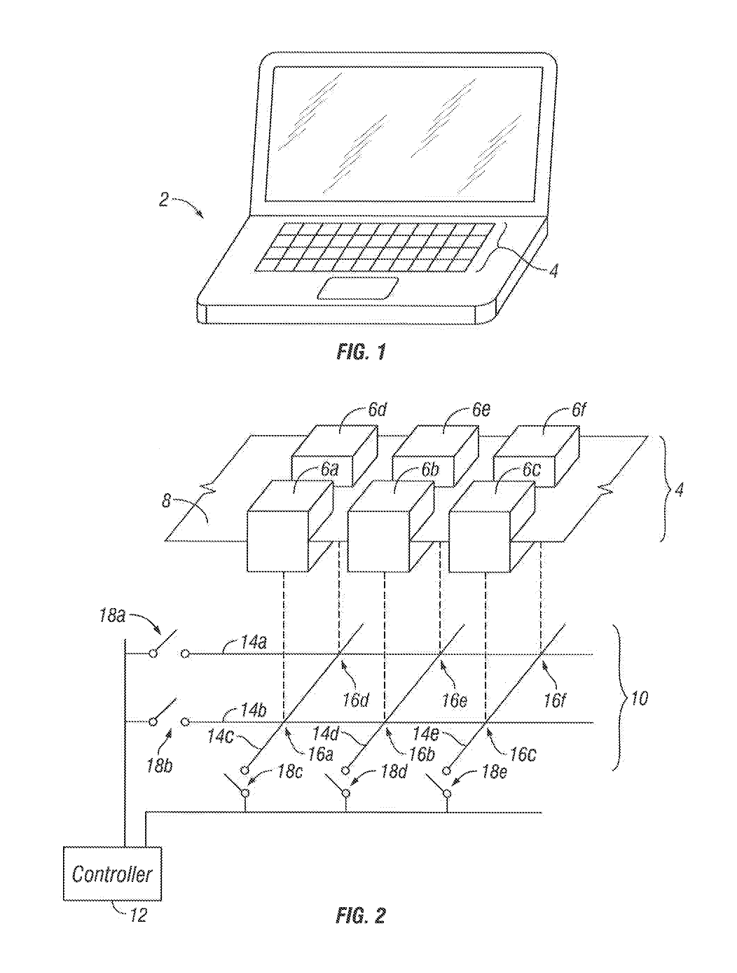

FIG. 1 illustrates an example device 2 that may utilize multi-state capacitive buttons. Device 2 includes keyboard 4. In the depicted embodiment, device 2 is a laptop computer, though numerous other devices may utilize multi-state capacitive buttons. For example, device 2 may be a laptop computer, a stand-alone keyboard, a smart phone, a tablet computer, an appliance, or any other suitable device utilizing a keyboard, keyboard, or button. In addition to keyboard 4, device 2 may include additional components that operate to measure and interpret signals associated with keyboard 4 to perform various functions. For example, device 2 may process input provided by one or more multi-state capacitive buttons of keyboard 4 to facilitate typing, trigger a sleep mode and/or reactivation, trigger the activation and deactivation of a light associated with keyboard 4, provide responsiveness to the physical movement of the buttons, distinguish between purposeful and accidental button presses, or provide any other suitable functionality.

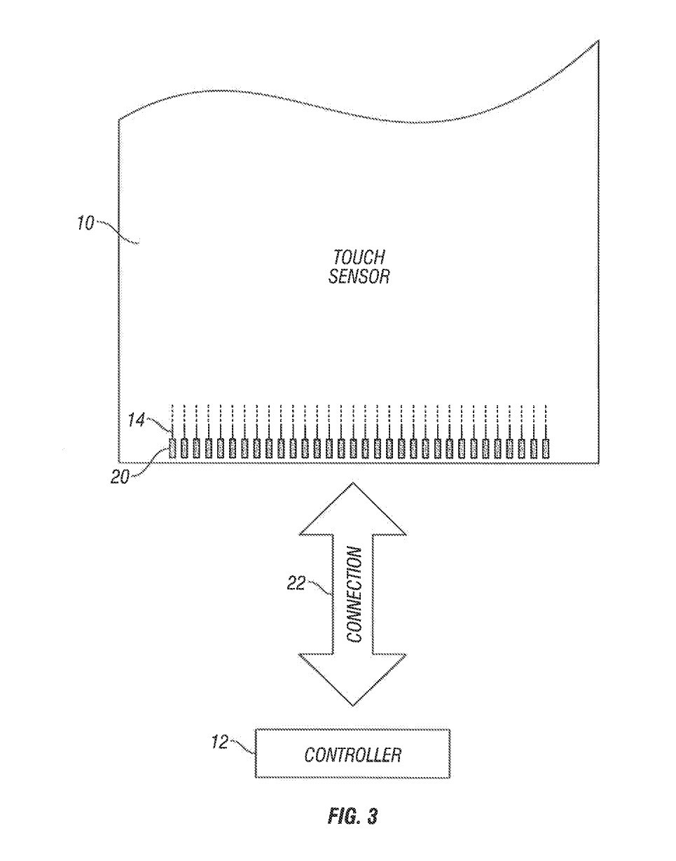

In some embodiments, keyboard 4 is a collection of one or more capacitive buttons and associated components. For example, keyboard 4 may be an integrated keyboard, a standalone keyboard, a numerical keypad, a set of one or more buttons on a smart phone or tablet computer, or a set of one or more buttons on any suitable electronic device. Keyboard 4 includes one or more multi-state capacitive buttons, which provide input to additional components of device 2 by affecting capacitive measurements of an associated capacitive sensor (e.g., touch sensor 10 of FIGS. 2 and 3). The components and operation of keyboard 4 are described further below with respect to FIG. 3.

FIG. 2 illustrates a portion of example keyboard 4, touch sensor 10, and touch-sensor controller 12 that may be used in device 2 of FIG. 1. Keyboard 4 is situated proximate to touch sensor 10, which is connected to touch-sensor controller 12. For purposes of illustration, a portion of keyboard 4 is shown separated from the corresponding portion of touch sensor 10 to illustrate the correlation of the components of keyboard 4 with the corresponding components of touch-sensor 10. Keyboard 4 includes buttons 6a-6f, which are housed in cover 8. Touch sensor 10 includes tracks 14a-14e, the intersections of which form capacitive nodes 16a-16f. Buttons 6a, 6b, 6c, 6d, 6e, and 6f correspond to capacitive nodes 16a, 16b, 16c, 16d, 16e, and 16f, respectively. Tracks 14a, 14b, 14c, 14d, and 14e are connected to touch-sensor controller 12 by switches 18a, 18b, 18c, 18d, and 18e, respectively.

Keyboard 4 may include any of the components and perform any of the functions described above with respect to FIG. 1. Keyboard 4 may include any suitable number, orientation, and configuration of buttons 6 and cover 4.

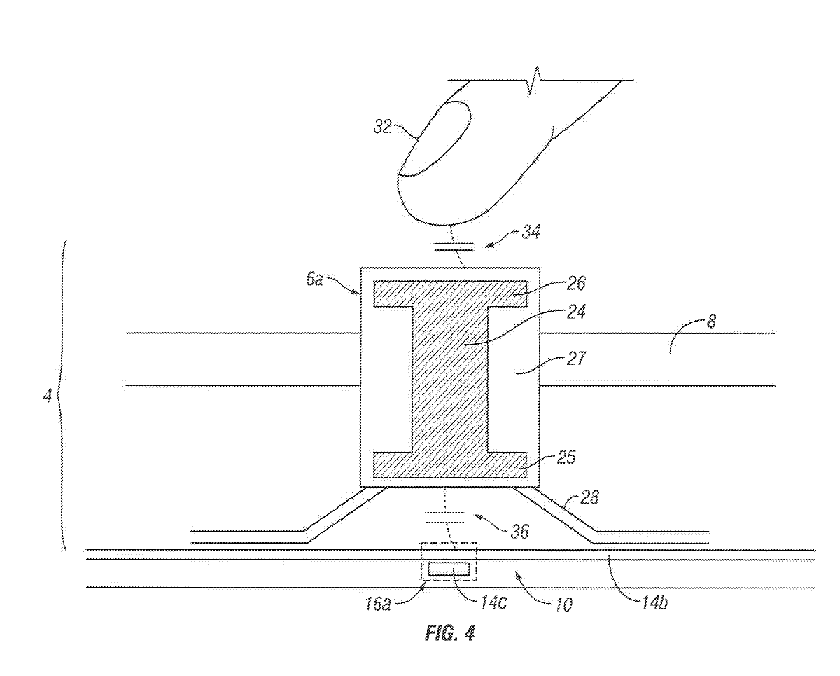

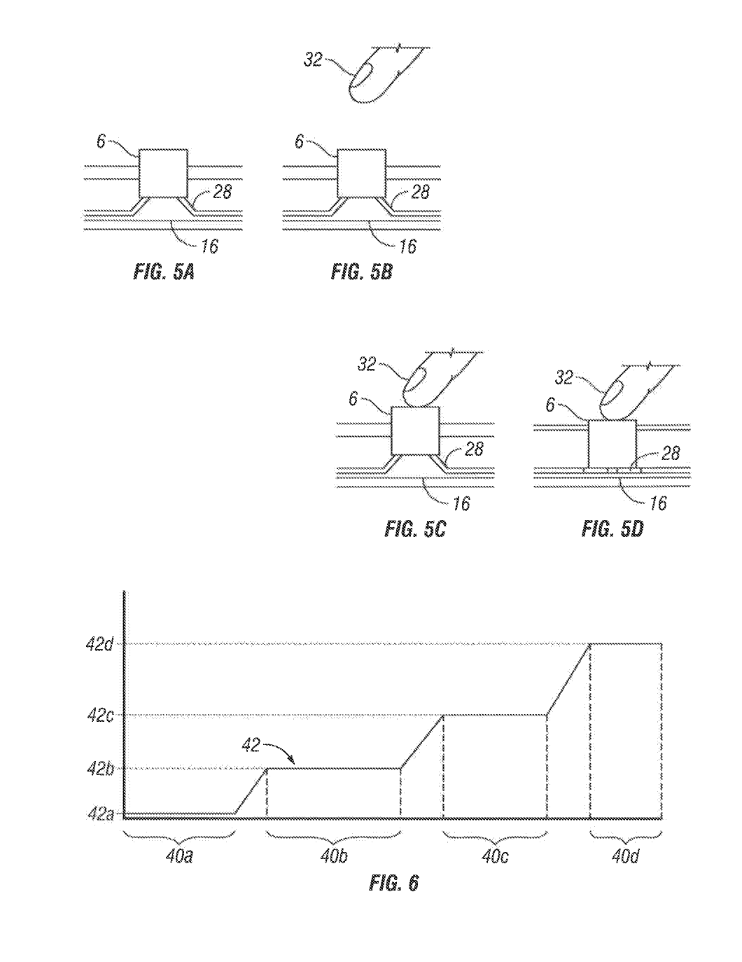

Buttons 6a-6f may be any suitable capacitive button that can be pressed to facilitate operation of a device. Each button 6 is situated proximate to and may change the capacitance of a capacitive node 16 (capacitive nodes 16 are described in further detail below). For example button 6a, is positioned above capacitive node 16a and may change the capacitance of capacitive node 16a based on the position of an object, such as finger, relative to button 6a and the distance between button 6a and capacitive node 16a (e.g., whether the button is in a pressed or unpressed state). This capacitive change may be measured to determine whether an object is near, touching, and/or pressing button 6a. Such measurements may enable responsiveness based on the extent to which buttons 6 are depressed. Such measurements may also trigger various other responses in device 2 and/or keyboard 4. Furthermore, these capacitive measurements may allow device 2 to distinguish between purposeful and accidental touches. For example, pressing a button with a finger may create a different capacitive change than pressing the button by another type of object, which may allow keyboard 4 to register button presses by fingers and not by other types of objects. The configuration and operation of buttons 6 are described further below with respect to FIGS. 4 and 5A-D.

Cover 8 may include any suitable material configured to house one or more buttons 6. Cover 8 may comprise metal, plastic, silicone, or any other suitable material. Cover 8 may have one or more openings through which one or more buttons 6 may pass. In some embodiments, such openings may form a substantially water-tight seal around buttons 6. In other embodiments, there may be a space between the edge of the opening and the button 6 situated within the opening. In some embodiments, cover 8 may interfere with or substantially prevent the propagation of electrical fields through the material of cover 8. In such embodiments, electrical fields may be directly or indirectly conveyed through cover 8 by buttons 6, which may improve the ability to perform proximity sensing in embodiments utilizing a grounded, conductive housing. Cover 8 may also provide improved physical and electrical isolation, which may provide improved safety and/or improved water resistance.

Touch sensor 10 may include any suitable circuitry and other components operable to perform capacitive sensing. Touch sensor 10 may include a printed circuit board (PCB) or any other suitable component. In some embodiments, touch sensor 10 includes tracks 14a-14e, which may form one or more capacitive nodes 16. Touch sensor 10 may perform mutual capacitance measurements, self-capacitance measurements, or any other suitable type of capacitive measurement. In some embodiments, touch sensor 10 may perform other types of measurements, such as, for example, resistive measurements, force measurements, or any other suitable measurement. Measurements of touch sensor 10 may indicate whether one or more buttons 6 are being pressed and/or whether an object, such as a user's finger, is near or touching one or more buttons 6. These measurements may also allow keyboard 4 to respond based on the extent to which a button 6 is depressed. For example, certain embodiments may provide tactile feedback (e.g., vibration, clicking, or any suitable feedback that allows the user to physically sense that the button 6 has been sufficiently pressed) when the capacitance measurement indicates that the button 6 is depressed. Measurements of touch sensor 10 may also enable the detection of various states of buttons 6, which may enable the triggering of various responses in device 2. The components, configuration, and operation of touch sensor 10 are discussed further below with respect to FIG. 3.

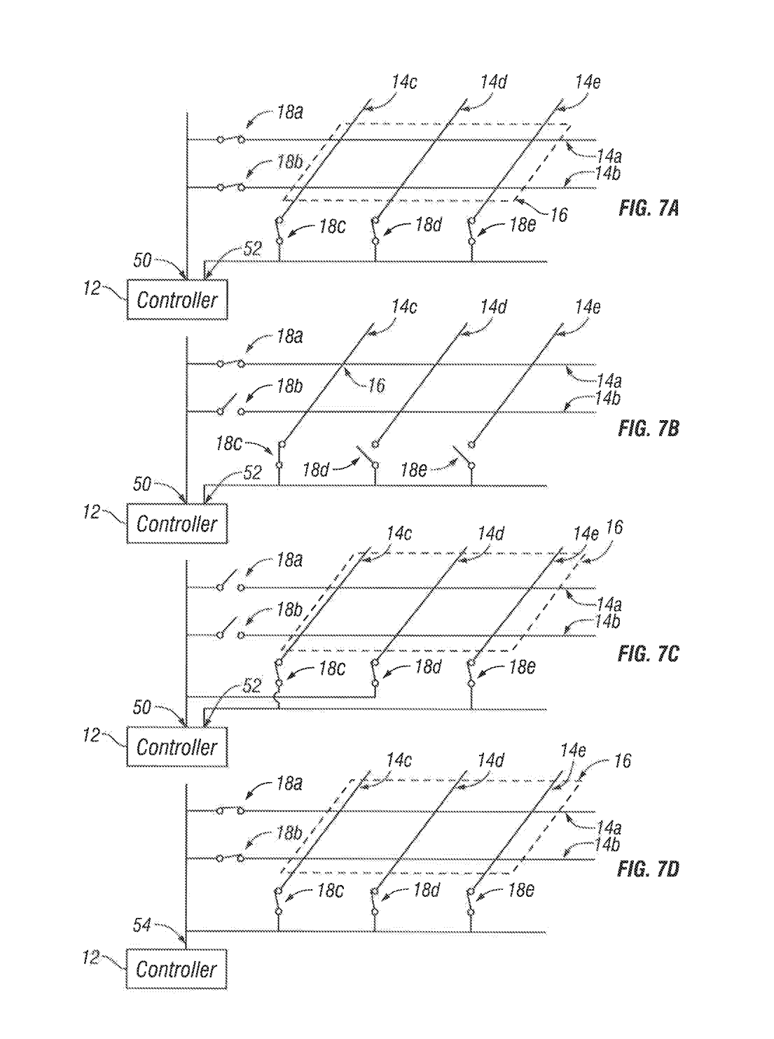

Touch-sensor controller 12 may include any circuitry and other components configured to control the operation of touch sensor 10. Touch-sensor controller 12 may control the sensing operations of touch sensor 10. For example, touch-sensor controller 12 may control the application of voltage to one or more tracks 14 and provide one or more corresponding measurements (such as, for example, capacitance measurements). Touch-sensor controller 12 may also switch between one or more operating modes. For example, touch-sensor controller 12 may cause touch sensor 10 to operate in an acquisition mode wherein touch sensor 10 uses less power while waiting for the user to approach the keyboard. Upon detecting the proximity of the user based on one or more capacitive measurements, touch-sensor controller 12 may trigger another type of operating mode in which button presses may be detected. As another example, touch-sensor controller 12 may switch between self-capacitance sensing and mutual-capacitance sensing. For example, touch-sensor controller 12 may use self-capacitance measurements when waiting for an object to come near keyboard 4 (as shown, for example, in FIG. 7D) at which point it may transition to using mutual-capacitance measurements (as shown, for example, in FIG. 7B). Self-capacitance and mutual capacitance sensing are discussed further below with respect to FIG. 3. Touch-sensor controller 12 may also trigger various responses in device 2 based on the capacitance measurements of touch sensor 10. The components, configuration, and operation of touch-sensor controller 12 are discussed further below with respect to FIG. 3.

Tracks 14a-14e may include electrode tracks and any other suitable components for performing capacitive measurements. In some embodiments, a capacitive node 16 may be formed at the intersection of two or more tracks 14. In a particular embodiment, tracks 14a and 14b are substantially parallel to each other and substantially perpendicular to tracks 14c-14e, and a capacitive node 16 may be formed at each intersection of tracks 14. Voltage may be applied to one or more tracks 14 during a sensing sequence, and the capacitance at a capacitive node 16 may be measured. Changes in the amount of capacitance experienced by one or more tracks 14 may indicate the proximity of an object, such as a finger, as well as the extent to which a button 6 is pressed. The components, configuration, and operation of tracks 14 are discussed further below with respect to FIG. 3.

Capacitive nodes 16a-16f represent areas of touch sensor 10 that are operable to provide discrete capacitive measurements. In the illustrated embodiments, each capacitive node 16 is located at the intersection of two tracks 14. For example, capacitive node 16a is located at the intersection of tracks 14b and 14c. In other embodiments, capacitive nodes 16 may correspond to other portions of touch sensor 10. For example, in an embodiment where multiple tracks 14 are driven together and multiple tracks 14 are sensed together, the corresponding capacitive node 16 may encompass the area bounded by the driven and sensed tracks 14. Various examples of different configurations of capacitive nodes 16 are described below regarding FIGS. 7A-7D. Different configurations of capacitive nodes 16 may provide different levels of sensitivity and or granularity with respect to capacitive measurements. For example, in embodiments where each button 6 is associated with a different capacitive node 16 (e.g., the embodiment shown in FIG. 2), user proximity and button-depression sensing may be determined separately for each button 6. In embodiments where multiple tracks 14 a sensed together (e.g., the configurations shown in FIGS. 7A, 7C, and 7D), the sensitivity of proximity sensing may be improved, though the ability to measure each button 6 independently may be reduced. Different configurations of capacitive nodes 16 may be achieved by configuring one or more switches 18.

Switches 18a-18e may be any suitable circuitry operable to connect or disconnect a track 14 from a portion of touch-sensor controller 12. Switches 18 may be part of touch sensor 10 or touch-sensor controller 12. Switches 18 may control which tracks 14 have voltage applied during a sensing sequence. For example, switches 18a and 18c may be closed so that track 14a operates as a drive line and track 14c operates as sense line, which may provide a capacitive measurement at capacitive node 16d corresponding to button 6d. Furthermore, the states of switches 18 may be adjusted sequentially to provide successive measurements at capacitive nodes 16a-16f. Additional configurations of switches 18 are discussed below regarding FIG. 7A-7D.

FIG. 3 illustrates an example touch sensor 10 and an example touch-sensor controller 12 that may be used in certain embodiments of FIGS. 1 and 2. Touch sensor 10 and touch-sensor controller 12 may be situated underneath or otherwise connected to keyboard 4 to detect the presence and location of a touch or the proximity of an object relative to keyboard 4. For example, touch sensor 10 and touch-sensor controller 12 may determine which button or buttons 6 are pressed, the extent to which each button 6 is pressed, and/or whether a finger or other external object is near or in contact with each button 6. Herein, reference to a touch sensor may encompass both the touch sensor and its touch-sensor controller, in particular embodiments. Similarly, reference to a touch-sensor controller may encompass both the touch-sensor controller and its touch sensor, in particular embodiments. Touch sensor 10 may include one or more touch-sensitive areas, in particular embodiments. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, in particular embodiments. Alternatively, in particular embodiments, reference to a touch sensor may encompass the electrodes of the touch sensor, but not the substrate(s) that they are disposed on.

An electrode (whether a ground electrode, a guard electrode, a drive electrode, or a sense electrode) may be an area of conductive material forming a shape, such as for example a disc, square, rectangle, thin line, other suitable shape, or suitable combination of these. One or more cuts in one or more layers of conductive material may (at least in part) create the shape of an electrode, and the area of the shape may (at least in part) be bounded by those cuts. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape (sometimes referred to as 100% fill), in particular embodiments. In particular embodiments, the conductive material of an electrode may occupy substantially less than 100% of the area of its shape. As an example and not by way of limitation, an electrode may be made of fine lines of metal or other conductive material (FLM), such as for example copper, silver, or a copper- or silver-based material; and the fine lines of conductive material may occupy approximately 5% of the area of its shape in a hatched, mesh, or other suitable pattern. Herein, reference to FLM may encompass such material, in particular embodiments. Although this disclosure describes or illustrates particular electrodes made of particular conductive material forming particular shapes with particular fill percentages having particular patterns, this disclosure contemplates any suitable electrodes made of any suitable conductive material forming any suitable shapes with any suitable fill percentages having any suitable patterns.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of polyethylene terephthalate (PET) or another suitable material, similar to the substrate with the conductive material forming the drive or sense electrodes). As an alternative, in particular embodiments, a thin coating of a dielectric material may be applied instead of the second layer of OCA and the dielectric layer. The second layer of OCA may be disposed between the substrate with the conductive material making up the drive or sense electrodes and the dielectric layer, and the dielectric layer may be disposed between the second layer of OCA and an air gap to a display of a device including touch sensor 10 and touch-sensor controller 12. As an example only and not by way of limitation, the cover panel may have a thickness of approximately 1 mm; the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

One or more portions of the substrate of touch sensor 10 may be made of PET or another suitable material. This disclosure contemplates any suitable substrate with any suitable portions made of any suitable material. In some embodiments, the substrate may include a printed circuit board (“PCB”). In particular embodiments, the drive or sense electrodes in touch sensor 10 may be made of ITO in whole or in part. In particular embodiments, the drive or sense electrodes in touch sensor 10 may be made of fine lines of metal or other conductive material. As an example and not by way of limitation, one or more portions of the conductive material may be copper or copper-based and have a thickness of approximately 5 μm or less and a width of approximately 10 μm or less. As another example, one or more portions of the conductive material may be silver or silver-based and similarly have a thickness of approximately 5 μm or less and a width of approximately 10 μm or less. This disclosure contemplates any suitable electrodes made of any suitable material.

In some embodiments, keyboard 4 may be implemented by overlaying a keyboard 4 on a touch screen. For example, a keyboard 4 may be placed over the touch screen of a smartphone or a tablet computer to enable tactile feedback when typing while utilizing the existing touch sensor 10 of the smartphone or tablet computer to detect button presses as described above. Other embodiments may not use smartphone or tablet computer touch screen components. For example, in certain embodiments (such as, for example, a standalone keyboard, a keyboard integrated into a laptop computer, a button panel that is not associated with a touch screen) touch sensor 10 may be a PCB or other suitable component.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by touch-sensor controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and touch-sensor controller 12 may measure the change in capacitance. For example, depressing button 6a may cause a change in capacitance at capacitive node 16a. By measuring changes in capacitance throughout the array, touch-sensor controller 12 may determine the position of the touch or proximity within the touch-sensitive area(s) of touch sensor 10. For example, touch-sensor controller 12 may determine which button or buttons 6 have been touched and/or depressed. Touch-sensor controller 12 may also determine if a user is within a threshold distance of keyboard 4.

In a self-capacitance implementation, touch sensor 10 may include an array of electrodes of a single type that may each form a capacitive node. When an object touches or comes within proximity of the capacitive node, a change in self-capacitance may occur at the capacitive node and touch-sensor controller 12 may measure the change in capacitance, for example, as a change in the amount of charge needed to raise the voltage at the capacitive node by a pre-determined amount. As with a mutual-capacitance implementation, by measuring changes in capacitance throughout the array, touch-sensor controller 12 may determine which button or buttons 6 are pressed, the extent to which each button 6 is pressed, and/or whether a finger or other external object is near or in contact with each button 6.

Certain embodiments may measure capacitance or a change in capacitance using any suitable method. For example, voltage may be applied to one or more tracks 14 by opening or closing one or more switches associated with one or more tracks 14. Such switches may connect one or more tracks 14 to other portions of touch sensor 10 or touch-sensor controller 12 such as, for example, a voltage supply rail, ground, virtual ground, and/or any other suitable component. Such methods may cause charge to be transferred to or from one or more portions of tracks 14, which may cause a corresponding transfer of charge on one or more portions of one or more other tracks 14. Certain embodiments may perform measurements using any suitable number of steps that facilitate capacitance measurements. For example, some embodiments may perform any suitable combination of pre-charging one or more tracks 14, charging one or more tracks 14, transferring charge between two or more tracks 14, discharging one or more tracks 14, and/or any other suitable step. In some embodiments, a transfer of charge may be measured directly or indirectly. For example, certain embodiments may utilize voltage measurements, current measurements, timing measurements, any other suitable measurement, or any combination thereof to measure capacitance or a change in capacitance at one or more capacitive nodes 16. Furthermore, certain embodiments may utilize additional circuitry (such as, for example, one or more integrators, amplifiers, capacitors, switches, audio-to-digital converters, and/or any other suitable circuitry) to perform and/or enhance such measurements. Certain embodiments may measure a value at a particular point in time, measure a change in a value over time, and/or perform any other suitable processing to determine one or more capacitance values associated with one or more capacitive nodes 16.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, in particular embodiments. Similarly, reference to a sense line may encompass one or more sense electrodes making up the sense line, and vice versa, in particular embodiments.

Touch sensor 10 may have drive and sense electrodes disposed in a pattern on one side of a single substrate. In such a configuration, a pair of drive and sense electrodes capacitively coupled to each other across a space between them may form a capacitive node 16. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. For example, capacitive node 16a of FIG. 2 is formed by the crossing of electrode tracks 14b and 14c. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. For example, a change in capacitance at capacitive node 16b of FIG. 2 may indicate that a user has touched button 6b. Touch-sensor controller 12 may detect and process the change in capacitance to determine the presence and location of the touch or proximity input. Furthermore, the amount of the capacitive change may indicate that a user is near, touching, and/or depressing a particular button 6, as shown in FIGS. 5A-5D and FIG. 6. Touch-sensor controller 12 may then communicate information about the touch or proximity input to one or more other components (such one or more central processing units (CPUs)) of a device that includes touch sensor 10 and touch-sensor controller 12, which may respond to the touch or proximity input by initiating a function of the device (or an application running on the device). Although this disclosure describes a particular touch-sensor controller having particular functionality with respect to a particular device and a particular touch sensor, this disclosure contemplates any suitable touch-sensor controller having any suitable functionality with respect to any suitable device and any suitable touch sensor.

Touch-sensor controller 12 may be one or more integrated circuits (ICs), such as for example general-purpose microprocessors, microcontrollers, programmable logic devices or arrays, application-specific ICs (ASICs). In particular embodiments, touch-sensor controller 12 comprises analog circuitry, digital logic, and digital non-volatile memory. In particular embodiments, touch-sensor controller 12 is disposed on a flexible printed circuit (FPC) bonded to the substrate of touch sensor 10, as described below. The FPC may be active or passive, in particular embodiments. In particular embodiments, multiple touch-sensor controllers 12 are disposed on the FPC. Touch-sensor controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes 16. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. For example, the processor unit may determine which button or buttons 6 are pressed, the extent to which each button 6 is pressed, and/or whether a finger or other external object is near or in contact with each button 6. The storage unit may store programming for execution by the processor unit, including programming for controlling the drive unit to supply drive signals to the drive electrodes, programming for processing measurement signals from the sense unit, and other suitable programming, in particular embodiments. Although this disclosure describes a particular touch-sensor controller having a particular implementation with particular components, this disclosure contemplates any suitable touch-sensor controller having any suitable implementation with any suitable components.

Tracks 14 of conductive material disposed on the substrate of touch sensor 10 may couple the drive or sense electrodes of touch sensor 10 to connection pads 20, also disposed on the substrate of touch sensor 10. As described below, connection pads 20 facilitate coupling of tracks 14 to touch-sensor controller 12. Tracks 14 may extend into or around (e.g. at the edges of) the touch-sensitive area(s) of touch sensor 10. Particular tracks 14 may provide drive connections for coupling touch-sensor controller 12 to drive electrodes of touch sensor 10, through which the drive unit of touch-sensor controller 12 may supply drive signals to the drive electrodes. Other tracks 14 may provide sense connections for coupling touch-sensor controller 12 to sense electrodes of touch sensor 10, through which the sense unit of touch-sensor controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 μm or less. As another example, the conductive material of tracks 14 may be silver or silver-based and have a width of approximately 100 μm or less. In particular embodiments, tracks 14 may be made of ITO in whole or in part in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 20) at an edge of the substrate of touch sensor 10 (similar to tracks 14).

Connection pads 20 may be located along one or more edges of the substrate, outside the touch-sensitive area(s) of touch sensor 10. As described above, touch-sensor controller 12 may be on an FPC. Connection pads 20 may be made of the same material as tracks 14 and may be bonded to the FPC using an anisotropic conductive film (ACF). Connection 22 may include conductive lines on the FPC coupling touch-sensor controller 12 to connection pads 20, in turn coupling touch-sensor controller 12 to tracks 14 and to the drive or sense electrodes of touch sensor 10. In another embodiment, connection pads 20 may be connected to an electro-mechanical connector (such as a zero insertion force wire-to-board connector); in this embodiment, connection 22 may not need to include an FPC. This disclosure contemplates any suitable connection 22 between touch-sensor controller 12 and touch sensor 10.

FIG. 4 illustrates a cross-sectional view of example components that may be used in keyboard 4 and touch sensor 10 of FIG. 2. The illustrated portion of keyboard 4 includes button 6a, cover 8, and support 28. The illustrated portion of touch sensor 10 includes tracks 14b and 14c, the intersection of which forms capacitive node 16a. Finger 32 and button 6a experience capacitive coupling 34, and button 6a and capacitive node 16a experience capacitive coupling 36. In some embodiments, button 6a includes a first material 24 and a second material 27.

First material 24 may be any suitable material having a sufficiently high dielectric constant to enable capacitive coupling. First material 24 may be a uniform material, a composite material, a combination of materials, any other suitable material, or any suitable combination thereof. For example, first material 24 may include a conductor or any material with a suitably high dielectric constant. Specific examples of first material 24 may include aluminum, plastic (e.g., polyester, a carbonized plastic, or any suitable plastic having a sufficiently high dielectric constant), glass, mica, rubber (e.g., a carbonized rubber having a sufficiently high carbon content, a conductive rubber, silicone rubber, neoprene rubber, or any suitable rubber having a sufficiently high dielectric constant), any other suitable metal, any other suitable conductive material, any other material with a sufficiently high dielectric constant to enable capacitive coupling, or any combination thereof. For example, in particular embodiments, first material 24 may be a combination of silicone rubber and aluminum or a combination of silicone rubber and conductive rubber. In various embodiments, first material 24 may have a dielectric constant greater than 2, a dielectric constant greater than 3, a dielectric constant greater than 5, a dielectric constant greater than 7, a dielectric constant greater than 10, or any suitably high dielectric constant to facilitate capacitive coupling. In various embodiments where second material 27 is present, first material 24 may have a dielectric constant that is at least 1.8 times higher than the dielectric constant of second material 27, at least 2 times higher than the dielectric constant of second material 27, at least 2.5 times higher than the dielectric constant of second material 27, or any suitable amount higher than the dielectric constant of second material 27.

First material 24 may have any suitable configuration that enables button 6a to convey an electric field generated by capacitive node 16a through the opening in cover 8 in which button 6a sits. For example, first material 24 may have a proximal portion 25 proximate to touch sensor 10 and a distal portion 26 distal from touch sensor 10. Proximal portion 25 may be configured to enable capacitive coupling 34 between finger 32 and button 6a, and distal portion 26 may be configured to enable capacitive coupling 36 between button 6a and capacitive node 16a. Furthermore, in some embodiments first material 24 may extend contiguously from proximal portion 25 to distal portion 26, while in other embodiments first material 24 may not extend contiguously from proximal portion 25 to distal portion 26.

Second material 27 may be any suitable material having a low dielectric constant. Second material may be an isolator or any suitable material that is sufficiently non-conductive. Second material 27 may be a uniform material, a composite material, a combination of materials, any other suitable material, or any suitable combination thereof. For example, second material 27 may be an isolator or any material with a suitably low dielectric constant. Specific examples of second material 27 may include plastic (e.g., polypropylene, polyethylene, polystyrene, polytetrafluoroethylene (“PTFE”), or any suitable plastic having a sufficiently low dielectric constant), a rubber having a sufficiently low dielectric constant, any other material with a sufficiently low dielectric constant, or any combination thereof. The dielectric constant of second material 27 may be lower than the dielectric constant of first material 24. In various embodiments, second material 27 may have a dielectric constant less than 4, a dielectric constant less than 3, a dielectric constant less than 2, or any suitably low dielectric constant. In various embodiments where second material 27 is present, second material 27 may have a dielectric constant that is at least 1.8 times smaller than the dielectric constant of first material 24, at least 2 times smaller than the dielectric constant of first material 24, at least 2.5 times smaller than the dielectric constant of first material 24, or any suitable amount smaller than the dielectric constant of first material 24. In embodiments where first material 24 is a conductor, the dielectric constant of second material 27 may be higher than the example values provided above. In embodiments containing a cover 8, a higher ratio of the dielectric constant of the first material 24 to the dielectric constant of the second material 27 may reduce the amount of charge and/or capacitive coupling lost to the cover 8.

In some embodiments, second material 27 may partially or completely surround first material 24. Second material 27 may provide electrical and/or capacitive isolation from other components, such as components that may be in mechanical contact with button 6 while also being grounded (e.g., certain embodiments of cover 8). In embodiments that include a cover 8 having one or more openings to receive one or more buttons 6, there may be an air gap between the edge of the opening and the corresponding button 6. In some such embodiments, this air gap may be sufficiently large to provide electrical and/or capacitive isolation between the button 6 and cover 8, in which case second material 27 may not be included. Second material 27 may also provide electrical isolation between finger 32 and one or more components of button 6 and touch sensor 10 (such as, for example, first material 24 or one or more tracks 14). For example, second material 27 may be an isolator when first material 24 is a conductor. Certain embodiments may omit second material 27 entirely, and in such embodiments first material 24 may be an electrically isolating material having a dielectric constant that is higher than the dielectric constant of certain components that surround button 6 (e.g., cover 8).

Support 28 may be any suitable structure that supports button 6a and deflects or otherwise moves or deforms to allow button 6a to move toward capacitive node 16a when button 6a is pressed. For example, support 28 may be a flexible material that flexes when force is applied to the top surface of button 6a, allowing button 6a to move toward capacitive node 16, and unflexes when the force is removed, allowing button 6a to move away from capacitive node 16 to its original position. Support 28 may also include a hinge, spring, a compressible material, any other suitable structure for facilitating button support and movement, or any combination thereof. Support 28 may be formed as part of keyboard 4 or touch sensor 10, or support 28 may be formed as a separate structure. In some embodiments, support 28 may include a separate gasket or seal.

Capacitive coupling 34 represents capacitive coupling that may occur between an external object and button 6a, and capacitive coupling 36 represents capacitive coupling that may occur between button 6a and capacitive node 16a. In the illustrated embodiment, the object coupling with button 6a is a user's finger 32, though other objects may be used. As finger 32 approaches button 6a, the total amount of capacitive coupling (e.g., capacitive coupling 34 in series with capacitive coupling 36) may increase, which may be detectable by touch-sensor controller 12. In such circumstances, the position and/or orientation of charges in first material 24 may change as a result of the interaction between finger 32 and the electrical field associated with the components of touch sensor 10 and button 6a. The amount of capacitive coupling 36 may also vary depending on the distance between button 6a and capacitive node 16a. Thus, the amount of capacitive coupling 36 may change as button 6a is pressed closer to touch sensor 10. Since the amount of capacitive coupling 36 affects the capacitance detected at capacitive node 16a by touch-sensor controller 12 (not shown), measuring the capacitance at capacitive node 16a enables the determination of the position of finger 32 relative to button 6a and the position of button 6a relative to touch sensor 10. For example, this measurement may allow touch-sensor controller 12 to determine which button or buttons 6 are being touched or depressed, the extent to which each button 6 is depressed, and/or whether a finger or other external object is near or in contact with each button 6.

In operation, touch sensor 10 provides a capacitive measurement indicating both the position of finger 32 relative to button 6a and the distance between button 6a and capacitive node 16a. For example, voltage may be applied to track 14b, while track 14c is sensed by touch-sensor controller 12. The distance between finger 32 and button 6a may affect the amount of capacitive coupling 34, and the amount of capacitive coupling 34 may in turn affect the amount of capacitive coupling 36. Similarly, the distance between button 6a and capacitive node 16a may affect the amount of capacitive coupling 36, causing the amount of capacitive coupling 36 to vary as button 6a is pressed toward capacitive node 16a. Since the capacitance value measured at capacitive node 16a varies based on the amount of capacitive coupling 36, measuring the capacitance at capacitive node 16a may enable the determination of both (1) the position of finger 32 relative to button 6a and (2) the extent to which button 6a is depressed.

Such measurements may enable the detection of various states of keyboard 4. For example, a capacitance measurement may indicate that a user is not near keyboard 4, that a user is near keyboard 4 but not touching button 6a, that finger 32 is touching but not depressing button 6a, that finger 32 is touching and partially depressing button 6a, that finger 32 is touching and fully depressing button 6a, or that button 6a is depressed but is not in contact with finger 32. Various responses may be triggered by the detection of one or more of such states. For example, detecting these states may enable the activation of a keyboard backlight when the user touches keyboard 4, the activation or deactivation of a power-saving mode based on the proximity of the user, distinct responses to partial and complete button presses, track pad functionality on the surface of buttons 6, security features based on particular types of button touches (e.g., unlocking device 2 by touching but not pressing certain buttons 6), or various other functions.

FIG. 5A-5D illustrate example button states that may be detected by touch-sensor controller 12 of FIG. 2.

FIG. 5A illustrates an example button state wherein finger 32 is not within a threshold distance of button 6. Since finger 32 is not exerting force on button 6, support 28 holds button 6 away from capacitive node 16 (i.e., in an unpressed state). Furthermore, finger 32 is not present to affect the capacitance at capacitive node 16. A capacitance measurement at capacitive node 16 may indicate that button 6 is in the state shown in FIG. 5A. This measurement may enable various functionalities. For example, when this state is detected, keyboard 4 and/or device 2 may enter a power-saving mode or hibernation mode, a backlight of keyboard 4 may be turned off, the user may be logged out of device 2, or any other suitable function may be performed. Any of these functions may be triggered depending on the amount of time that button 6 has been in the state shown in FIG. 5A.

FIG. 5B illustrates an example button state wherein finger 32 is within a threshold distance of button 6 but is not in contact with button 6. Since finger 32 is not exerting force on button 6, support 28 holds button 6 away from capacitive node 16 (i.e., in an unpressed state). Furthermore, the proximity of finger 32 to button 6 may change the capacitance at capacitive node 16. A capacitance measurement at capacitive node 16 may indicate that button 6 is in the state shown in FIG. 5B. This measurement may enable various functionalities. For example, when this state is detected, a backlight of keyboard 4 may be turned on or off, the user may be logged into device 2, the user may be prompted to log into device 2, device 2 and/or keyboard 4 may exit a power-saving mode or hibernation mode, or any other suitable function may be performed. Any of these functions may be triggered depending on the amount of time that button 6 has been in the state shown in FIG. 5B. Furthermore, certain functions may be triggered depending on which state was previously detected.

FIG. 5C illustrates an example button state wherein finger 32 is in contact with button 6 but has not depressed button 6. Since finger 32 is touching but not exerting force on button 6, support 28 holds button 6 away from capacitive node 16 (i.e., in an unpressed state). However, by touching the surface of button 6, finger 32 may cause a greater change in the capacitance of capacitive node 16 than it did when it was nearby but not touching button 6. A capacitance measurement at capacitive node 16 may indicate that button 6 is in the state shown in FIG. 5C. This measurement may enable various functionalities. For example, a backlight of keyboard 4 or button 6 may be turned on, the user may be logged into device 2, the user may be prompted to log into device 2, device 2 and/or keyboard 4 may exit a power-saving mode or hibernation mode, or any other suitable function may be performed. Any of these functions may be triggered depending on the amount of time that button 6 has been in the state shown in FIG. 5C, and certain functions may be triggered depending on which state was previously detected. Furthermore, detecting this state may allow device 2 to distinguish between button touches and presses, which may enable additional functionality. For example, passwords may require certain buttons 6 to be touched but not pressed. Additionally, measuring multiple buttons 6 in this manner may provide touch pad functionality on the surface of keyboard 4 as the user moves finger 32 across different buttons 6.

FIG. 5D illustrates an example button state wherein finger 32 is fully depressing button 6. Since finger 32 is exerting force on button 6, support 28 has deflected or otherwise moved to allow button 6 to move toward capacitive node 16 (i.e., button 6 is in a depressed state). The contact between finger 32 and button 6, as well as the reduced distance between button 6 and capacitive node 16 may cause a greater change in the capacitance of capacitive node 16 than in the states shown in FIGS. 5A-5C. A capacitance measurement at capacitive node 16 may indicate that button 6 is in the state shown in FIG. 5D. This measurement may enable various functionalities. For example, device 2 and/or keyboard may register a button press that is distinguishable from a button touch (as shown in FIG. 5C). Because this capacitive measurement enables the detection of button presses without requiring the creation of a physical and/or galvanic connections between electrodes, mechanical wear on certain components may be reduced, which may reduce the frequency and/or cost of repairs. Furthermore, because the capacitive coupling between finger 32 and button 6 allows a button press by finger 32 and button pressed by another type of object to be distinguished, accidental touches may detected and handled appropriately. For example, the accidental pressing of a button 6 on a smartphone while in the user's pocket may be ignored.

In some embodiments, touch-sensor controller 12 may detect states that are not shown in FIGS. 5A-5D. For example, touch-sensor controller 12 may determine that button 6 is being pressed by an object that is not the user's finger 32. In such embodiments, the closer proximity of button 6 to capacitive node 16 due to the depressed state of button 6 may affect the capacitance of capacitive node 16. However, if the object pressing button 6 does not have the conductive properties of a user's finger 32 (e.g., if a non-conductive object is pressing against keyboard 4), the measured capacitance of capacitive node 16 may be different from the capacitance measured in the state shown in FIG. 5D. Since such a measurement may indicate an accidental touch, touch-sensor controller 12 may trigger an appropriate response (e.g., ignoring the button press, triggering the execution of accidental touch computer logic, or any other suitable response). As another example of a detectable button state, touch-sensor controller 12 may detect a capacitance change that is in between the value detected when a finger is in contact with but not depressing button 6 (i.e. the state shown in FIG. 5C) and the value detected when a finger is in contact with and depressing button 6 (i.e. the state shown in FIG. 5D). Touch-sensor controller 12 may interpret such a reading as a partial button press and trigger an appropriate response. For example, if a user is inputting text, partial button presses and complete button presses may be treated as lower case letters and upper case letters, respectively. Furthermore, some embodiments may incorporate different types of measurements in addition to the capacitive measurements described above. For example, force measurements, resistive measurements, or any other suitable type of measurement may be utilized.

FIG. 6 illustrates a graph of example measurements that may be made by touch-sensor controller 12 of FIG. 2 when button 6 is in the states of FIGS. 5A-5D. FIG. 6 depicts measured values 42a-42d, which corresponding to portions 40a-40d, respectively. The change in value 42 (i.e. the transition from portion 40a to portion 40b, from portion 40b to portion 40c, and from portion 40c to portion 40d) represents the capacitive value measured at capacitive node 16 as button 6 transitions through the states shown in FIGS. 5A-5D. As discussed above with respect to FIG. 3, values 42a-42d may be capacitance measurements, voltage measurements, current measurements, charge measurements, or any other suitable measurement indicating the capacitance at a capacitive node 16. Furthermore, as discussed above with respect to FIG. 3, values 42a-42d may be measured using mutual capacitance sensing methods, self-capacitance sensing methods, or any suitable sensing method. The sensing method utilized in particular embodiments may be dependent upon aspects of one or more components used in a particular device 2 (e.g., the return path to ground in a particular device 2).

Portion 40a corresponds to the capacitance measurement of capacitive node 16 when button 6 is in the state shown in FIG. 5A. When finger 32 is not near button 6 and button 6 is an undepressed position, capacitive node 16 may experience little or no change in capacitance relative to its baseline state. This state of button 6 may be detected by determining when the capacitance measurement exceeds or falls below a particular threshold value, by determining when the capacitance measurement falls within a predetermined value range, or by any other suitable method. A particular value measured in portion 40a is represented by value 42a. For example, in embodiments where the measured value is a change in capacitance, value 42a may be approximately 0 picofarads (pF) or any suitable value associated with the state shown in FIG. 5A.

Portion 40b corresponds to the capacitance measurement of capacitive node 16 when button 6 is in the state shown in FIG. 5B. When finger 32 is near but not touching button 6 and button 6 is an undepressed position, capacitive node 16 may experience a change in capacitance relative to its baseline state. This state of button 6 may be detected by determining when the capacitance measurement exceeds or falls below a particular threshold value, by determining when the capacitance measurement falls within a predetermined value range, or by any other suitable method. A particular value measured in portion 40b is represented by value 42b. For example, in embodiments where the measured value is a change in capacitance, value 42b may be approximately in the range of 0.1 pF to 1 pF or any suitable range associated with the state shown in FIG. 5B.

Portion 40c corresponds to the capacitance measurement of capacitive node 16 when button 6 is in the state shown in FIG. 5C. When finger 32 is touching but not depressing button 6, capacitive node 16 may experience a change in capacitance relative to its baseline state. This change in capacitance may be greater than the change experienced when finger 32 is near but not touching button 6. This state of button 6 may be detected by determining when the capacitance measurement exceeds or falls below a particular threshold value, by determining when the capacitance measurement falls within a predetermined value range, or by any other suitable method. A particular value measured in portion 40c is represented by value 42c. For example, in embodiments where the measured value is a change in capacitance, value 42c may be approximately in the range of 1 pF to 8 pF or any suitable range associated with the state shown in FIG. 5C.

Portion 40d corresponds to the capacitance measurement of capacitive node 16 when button 6 is in the state shown in FIG. 5D. When finger 32 is touching and depressing button 6, capacitive node 16 may experience a change in capacitance relative to its baseline state. This change in capacitance may be greater than the change experienced when finger 32 touching but not depressing button 6. This state of button 6 may be detected by determining when the capacitance measurement exceeds or falls below a particular threshold value, by determining when the capacitance measurement falls within a predetermined value range, or by any other suitable method. For example, determining that a measured capacitance change has exceeded a threshold value (e.g., 8 pF or any other suitable value) may indicate that button 6 is in the state shown in FIG. 5D. A particular value measured in portion 40d is represented by value 42d. For example, in embodiments where the measured value is a change in capacitance, value 42d may be approximately 8 pF or higher (e.g., 10 pF, 100 pF, 1000 pF, or any other suitable value above 8 pF), or value 4d may be any suitable value associated with the state shown in FIG. 5D.

FIGS. 7A-7D depict example configurations of touch sensor 10 and touch-sensor controller 12 that may be used to detect whether the user is located near keyboard 4. Touch-sensor controller 12 may switch between these configurations based on various triggers. Measurement thresholds and/or ranges may be adjusted based on which configuration touch sensor 10 and touch-sensor controller 12 are currently using. Touch-sensor controller 12 may also configure whether self-capacitance or mutual capacitance measurements are taken. For example, mutual capacitance measurements may be provided in the configurations of FIGS. 7A-7C, while self-capacitance measurements may be provided in the configurations of FIG. 7D.

FIG. 7A depicts an example configuration of touch sensor 10 and touch-sensor controller 12. Connection 50 represents a drive line output that may be used to apply voltage to one or more tracks 14. Connection 52 represents a sense line input that may be used to measure the capacitance of one or more tracks 14. Switches 18a-18e are closed so that tracks 14a and 14b are driven while tracks 14c-14e are sensed. Touch-sensor controller 12 may also configure which set of tracks 14 is driven and which is sensed (e.g., tracks 14c-14e may be driven while tracks 14a and 14b are sensed). This configuration may provide a wider and/or more sensitive capacitive node 16 than configurations wherein a single track 14 is driven and a single track 14 is sensed (e.g., the configuration of FIG. 7B). Because a single capacitance measurement is taken via input 52, touch-controller sensor 12 may not be able to distinguish between capacitive effects at different buttons 6. This configuration may be used to provide improved detection of when the user approaches keyboard 4 (e.g., detecting the state shown in FIG. 5B). In some embodiments, this configuration may be used when the user is not detected near keyboard 4, and detection of the user near keyboard 4 may trigger a switch to a different configuration (e.g., the configuration shown in FIG. 7B).

FIG. 7B depicts an example configuration of touch sensor 10 and touch-sensor controller 12. Connection 50 represents a drive line output that may be used to apply voltage to one or more tracks 14. Connection 52 represents a sense line input that may be used to measure the capacitance of one or more tracks 14. Switch 18a is closed so that track 14a is driven, and switch 18c is closed so that track 14c is sensed. This configuration provides capacitive sensing at the intersection of tracks 14a and 14c (i.e. capacitive node 16). Touch-sensor controller 12 may also configure which set of tracks 14 is driven and which is sensed. For example, different combinations of tracks 14 may be driven and sensed in succession so that touch-sensor controller may detect capacitive changes at each intersection of tracks 14.

FIG. 7C depicts an example configuration of touch sensor 10 and touch-sensor controller 12. Connection 50 represents a drive line output that may be used to apply voltage to one or more tracks 14. Connection 52 represents a sense line input that may be used to measure the capacitance of one or more tracks 14. Switches 18c-18e are closed so that track 14d is driven while tracks 14c and 14e are sensed. Any combination of driven and sensed tracks 14 may be used, and touch-sensor controller 12 may also configure which set of tracks 14 is driven and which is sensed (e.g., tracks 14c-14e may be driven while tracks 14a and 14b are sensed). In this configuration, since multiple tracks 14 are sensed simultaneously, touch-controller sensor 12 may not be able to distinguish between capacitive effects at different buttons 6. In other words, the sensitive area extends between all sensed tracks 14. Furthermore, because the driven track or tracks 14 are parallel to the sensed lines, touch-sensor controller 12 may not be able to distinguish between capacitive changes at different points along the sensed tracks 14. This configuration may be used to provide improved detection of when the user approaches keyboard 4 (e.g., detecting the state shown in FIG. 5B). In some embodiments, this configuration may be used when the user is not detected near keyboard 4, and detection of the user near keyboard 4 may trigger a switch to a different configuration (e.g., the configuration shown in FIG. 7B).

FIG. 7D depicts an example configuration of touch sensor 10 and touch-sensor controller 12. Connection 54 represents a connection to touch-sensor controller 12 that may be used to provide self-capacitance measurements. Switches 18a-18e are closed so that voltage may be applied to all tracks 14 to provide a single self-capacitance measurement. This configuration may be used to provide improved detection of when the user approaches keyboard 4 (e.g., detecting the state shown in FIG. 5B). In some embodiments, this configuration may be used when the user is not detected near keyboard 4, and detection of the user near keyboard 4 may trigger a switch to a different configuration (e.g., the configuration shown in FIG. 7B).

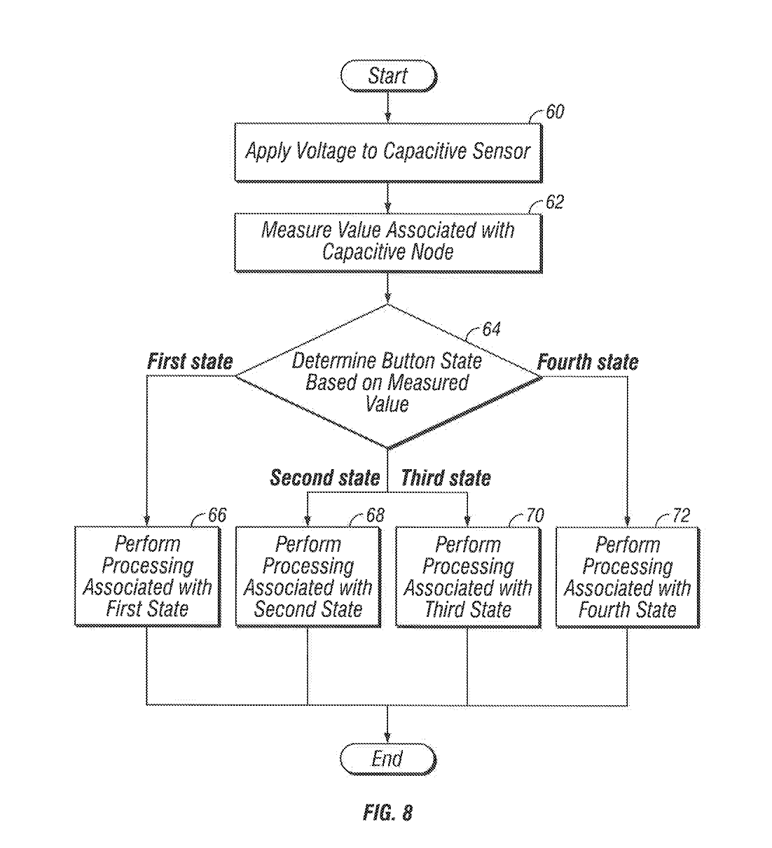

FIG. 8 illustrates an example keyboard sensing sequence that may be performed with a multi-state capacitive button. In some embodiments, these steps are carried out using one or more components of FIGS. 1-7. Furthermore, although this disclosure describes and illustrates particular components, devices, or systems carrying out particular steps in FIG. 8, this disclosure contemplates any suitable combination of any suitable components, devices, or systems carrying out any suitable steps in FIG. 8.

At step 60, voltage is applied to a capacitive sensor. For example, voltage from a voltage supply rail may be applied to track 14a of touch sensor 10. Depending on the configuration of switches 18 and/or other components, voltage may be applied to a single track 14 or multiple tracks 14. Applying voltage in this manner may cause current to flow through track 14a, and track 14a may generate an electrical field that may affect nearby components, such as, for example, another track 14 or button 6a.

At step 62, a value associated with the capacitive sensor is measured. For example, touch-sensor controller 12 may measure a change in capacitance at a capacitive node 16. The electrical field generated during step 60 may cause capacitive coupling between two or more tracks 14. This capacitance may serve as a baseline from which capacitance changes caused by finger 32 may be measured. The capacitance may be measured by measuring the capacitance directly or by measuring any suitable value that is proportional to the capacitance at capacitive node 16 (e.g., values related to voltage, current, charge, or other suitable values associated with the capacitive sensor). Furthermore, some embodiments may measure the change in capacitance (or related values) over time. For example, certain embodiments may use integration to measure a change in capacitance at capacitive node 16 over time.

At step 64, the state of a button 6 is determined based at least on the value measured during step 62. For example, touch-sensor controller 12 may measure a capacitive change at a capacitive node 16. This value may be compared to various threshold values or value ranges to determine both the position of an object (e.g., finger 32) relative to a button 6 and the extent to which the button 6 is depressed, as explained above regarding FIGS. 5A-5D and 6. If the measured value indicates that button 6 is not depressed and that an object, such as finger 32, is not sufficiently close to button 6, the sequence proceeds to step 66. If the measured value indicates that button 6 is not depressed and that the object is sufficiently close to but not touching button 6, the sequence proceeds to step 68. If the measured value indicates that the object is touching but not depressing button 6, the sequence proceeds to step 70. If the measured value indicates that the object is touching and depressing button 6, the sequence proceeds to step 70. Particular embodiments may detect additional and/or alternate states of button 6. For example, touch-sensor controller 12 may detect one or more states associated with partial depression of a button 6, and such states may trigger responses that are different from those triggered by complete depression of button 6. As another example, the responses triggered by a particular state may be different depending on the amount of time that button 6 remains in that state. The responses triggered by a particular state may be different depending on the state of button 6 prior to the newly detected state.

At step 66, processing associated with the detected state (e.g., the state is illustrated in FIG. 5A) is performed. For example, when this state is detected, keyboard 4 and/or device 2 may enter a power-saving mode or hibernation mode, a backlight of keyboard 4 may be turned off, the user may be logged out of device 2, or any other suitable function may be performed. Any of these functions may be triggered depending on the amount of time that button 6 has been in the state detected during step 64.

At step 68, processing associated with the detected state (e.g., the state is illustrated in FIG. 5B) is performed. For example, when this state is detected, a backlight of keyboard 4 may be turned on or off, the user may be logged into device 2, the user may be prompted to log into device 2, device 2 and/or keyboard 4 may exit a power-saving mode or hibernation mode, or any other suitable function may be performed. Any of these functions may be triggered depending on the amount of time that button 6 has been in the present state. Furthermore, certain functions may be triggered depending on which state was previously detected.

At step 70, processing associated with the detected state (e.g., the state is illustrated in FIG. 5C) is performed. For example, a backlight of keyboard 4 or button 6 may be turned on, the user may be logged into device 2, the user may be prompted to log into device 2, device 2 and/or keyboard 4 may exit a power-saving mode or hibernation mode, or any other suitable function may be performed. Any of these functions may be triggered depending on the amount of time that button 6 has been in the present state, and certain functions may be triggered depending on which state was previously detected. Furthermore, detecting this state may allow device 2 to distinguish between button touches and presses, which may enable additional functionality. For example, passwords may require certain buttons 6 to be touched but not pressed. Additionally, measuring multiple buttons 6 in this manner may provide touch pad functionality on the surface of keyboard 4 as the user moves finger 32 across different buttons 6.

At step 72, processing associated with the detected state (e.g., the state is illustrated in FIG. 5D) is performed. For example, device 2 and/or keyboard may register a button press that is distinguishable from a button touch (as shown in FIG. 5C). This processing may involve registering button presses while the user is typing or otherwise interacting with a button 6 in a traditional manner. Because this processing involves the detection of button presses without requiring the creation of a physical and/or galvanic connections between electrodes on touch sensor 10, mechanical wear on certain components may be reduced, which may reduce the frequency and/or cost of repairs. Furthermore, because the capacitive coupling between finger 32 and button 6 allows a button press by finger 32 and button pressed by another type of object to be distinguished, accidental touches may detected and handled appropriately. For example, the accidental pressing of a button 6 on a smartphone while in the user's pocket may be ignored.

Particular embodiments may repeat the steps of FIG. 8, where appropriate. For example, these steps may be performed on different pairs of tracks 14 in succession. Moreover, although this disclosure describes and illustrates particular steps in FIG. 8 as occurring in a particular order, this disclosure contemplates any suitable steps in FIG. 8 occurring in any suitable order. For example, one or more additional steps involving the configuration of switches 18 may be performed prior to the performance of step 60. Furthermore, the steps of FIG. 8 may be performed at different times during the operation of touch sensor 10.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. For example, while the embodiments of FIGS. 2 and 7A-7D are shown as having tracks 14a-14e and switches 18a-18e, any suitable number, type, and configuration of tracks 14 and/or switches 18 may be used. As another example, any number, type, and configuration of buttons 6 may be used, and touch-sensor controller 12 may use any suitable number and type of measurements to detect the one or more states of buttons 6. As yet another example, touch sensor 10 may include one or more capacitive switches in place of or in addition to intersecting tracks 14 to measure the capacitance at capacitive nodes 16. Touch-sensor controller 12 may detect states other than or in addition to the button states described herein. Furthermore, in response to the various states of buttons 6 detected by touch-sensor controller 12, touch-sensor controller 12 may trigger responses in place of or in addition to the responses described herein.

Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An apparatus comprising:
a capacitive sensor;
a button comprising a first material having a first dielectric constant, the first material comprising:
a distal coupling portion distal from the capacitive sensor and configured to capacitively couple with an object; and
a proximal coupling portion proximal to the capacitive sensor and configured to capacitively couple with the capacitive sensor;
a support connected to the button and configured to deflect when the button is pressed to allow the button to move closer to the capacitive sensor; and
a controller connected to the capacitive sensor and configured to measure a value associated with an amount of capacitive coupling between the button and the capacitive sensor, the amount of capacitive coupling between the button and the capacitive sensor based at least on the following:
an amount of capacitive coupling between the distal coupling portion and the object; and
a distance between the proximal coupling portion and the capacitive sensor.

2. The apparatus of claim 1, wherein the controller is further configured to detect first and second states based on the value, the first state indicating that the object is in contact with the button and that the button is not depressed, and the second state indicating that the object is in contact with the button and that the button is depressed.

3. The apparatus of claim 2, wherein the controller is further configured to detect third and fourth states based on the value, the third state indicating that the object is not within a threshold distance of the button, and the fourth state indicating that the object is within the threshold distance of the button but is not in contact with the button.

4. The apparatus of claim 1, wherein the coupling portion extends contiguously through the button from the first portion to the second portion.

5. The apparatus of claim 1, wherein the button further comprises a second material having a second dielectric constant, a portion of the second material at least partially surrounding a portion of the first material, wherein the first dielectric constant is at least 2 times greater than the second dielectric constant.

6. The apparatus of claim 1, wherein the capacitive sensor comprises an intersection of a first electrode track and a second electrode track.

7. The apparatus of claim 1, wherein depression of the button does not create a galvanic connection between portions of one or more electrode tracks of the capacitive sensor.

8. The apparatus of claim 1, wherein the controller is configured to measure the value using mutual capacitance sensing.

9. The apparatus of claim 1, wherein the first dielectric constant is at least 3.

10. The apparatus of claim 1, wherein the first material is a conductor.

11. The apparatus of claim 1, further comprising a cover comprising:
a distal cover surface distal from the capacitive sensor;
a proximal cover surface proximal to the capacitive sensor; and
a channel extending from the distal cover surface to the proximal cover surface, the channel configured to receive the button.

12. A method comprising:
applying voltage to a capacitive sensor, the capacitive sensor proximate to a button that is capable of being depressed relative to the capacitive sensor;
measuring, by a controller, a value associated with an amount of capacitive coupling between the button and the capacitive sensor, the amount of capacitive coupling between the button and the capacitive sensor based at least on the following:
an amount of capacitive coupling between a first portion of the button and an object; and
a distance between a second portion of the button and the capacitive sensor;
determining, by the controller based on the value, a state of the button from a plurality of possible states of the button, the plurality of possible states comprising:
a first state indicating that the object is in contact with the button and that the button is not depressed; and
a second state indicating that the object is in contact with the button and that the button is depressed.

13. The method of claim 12, wherein the plurality of possible states further comprises:
a third state indicating that the object is not within a threshold distance of the button; and
a fourth state indicating that the object is within the threshold distance of the button but is not in contact with the button.

14. The method of claim 13, wherein the plurality of possible states further comprises a fifth state indicating that the button is depressed, but the object is not in contact with the button.

15. The method of claim 12, wherein:
each of the plurality of states is associated with a value range; and
determining the state of the button comprises determining the value range in which the measured value falls.

16. The method of claim 12, wherein the button comprises a first material configured to capacitively couple with the capacitive sensor and the object, the first material comprising at least one of the following materials:
a conductive metal;
a rubber;
glass; and
a carbonized plastic.

17. The method of claim 12, wherein:
applying voltage to the capacitive sensor comprises applying voltage to a first electrode track of the capacitive sensor; and
measuring the value comprises measuring a capacitance associated with a second electrode track of the capacitive sensor, the first and second electrode tracks being substantially perpendicular.

18. The method of claim 12, wherein:
applying voltage to the capacitive sensor comprises applying voltage to a plurality of electrode tracks of the capacitive sensor substantially simultaneously; and
measuring the value comprises measuring a capacitance associated with capacitive coupling experienced by the plurality of electrode tracks.

19. The method of claim 12, wherein:
applying voltage to the capacitive sensor comprises applying voltage to a first plurality of substantially parallel electrode tracks of the capacitive sensor substantially simultaneously; and
measuring the value comprises measuring a capacitance associated with capacitive coupling experienced by a second plurality of electrode tracks of the capacitive sensor.

20. The method of claim 19, wherein the first plurality of electrode tracks is substantially parallel to the second plurality of electrode tracks.

21. The method of claim 19, wherein the first plurality of electrode tracks is substantially perpendicular to the second plurality of electrode tracks.

22. The method of claim 16, wherein the first material has a first dielectric constant, and the button further comprises a second material having a second dielectric constant, the first dielectric constant being at least 2 times greater than the second dielectric constant.

23. An apparatus comprising:
a capacitive sensor comprising an intersection of a first electrode track and a second electrode track;
a button comprising:
a first material having a first dielectric constant, the first material comprising a distal coupling portion distal from the capacitive sensor and a proximal coupling portion proximal to the capacitive sensor; and
a second material having a second dielectric constant, the first dielectric constant being at least 2 times greater than the second dielectric constant, a portion of the second material at least partially surrounding a portion of the first material;
a cover comprising:
a distal cover surface distal from the capacitive sensor;
a proximal cover surface proximal to the capacitive sensor; and
a channel extending from the distal cover surface to the proximal cover surface, the channel configured to receive the button;
a support connected to the button and configured to deflect when the button is pressed to allow the button to move closer to the capacitive sensor; and
a controller connected to the capacitive sensor and configured to measure a value associated with an amount of capacitive coupling between the button and the capacitive sensor, the amount of capacitive coupling between the button and the capacitive sensor based at least on the following:
an amount of capacitive coupling between the distal coupling portion and an object; and
a distance between the proximal coupling portion and the capacitive sensor.
